(19) United States
(12) Patent Application Publication
(10) Pub. No.: US 2020/0270806 A1
(43) Pub. Date: Aug. 27, 2020

(54) METHOD FOR DYEING ELASTOMER PARTICLE FOAMS

(71) Applicant: BASF SE, Ludwigshafen am Rhein (DE)

(72) Inventors: Frank PRISSOK, Lemfoerde (DE); Michael HARMS, Lemfoerde (DE)

(73) Assignee: BASF SE, Ludwigshafen am Rhein (DE)

(21) Appl. No.: 16/758,315

(22) PCT Filed: Oct. 25, 2018
(86) PCT No.: PCT/EP2018/079293

§ 371 Date: Apr. 22, 2020

(30) Foreign Application Priority Data
Oct. 26, 2017 (EP) 17198591.4

(51) Int. Cl. D06P 3/24; C08J 9/22

(52) U.S. Cl. CPC D06P 3/24; C08J 2375/04; C08J 2300/26; C08J 9/22

(57) ABSTRACT

The present invention relates to a process for producing colored foamed particles consisting of an elastomer (E), at least comprising the providing of foamed particles made of at least one elastomer (E), and the contacting of the particles with a mixture (MF) comprising a dye (F) and a carrier fluid (TF) to obtain colored foamed particles, wherein the carrier fluid (TF) has a polarity suitable for sorption of the carrier fluid into the elastomer. The present invention further relates to cpspolored foamed particles obtained or obtainable by such a process, and to the use of the colored foamed particles of the invention for production of shaped bodies, especially of footwear soles, parts of a footwear sole, bicycle saddles, cushions, mattresses, underlays, handles, protective films, floor coverings, and components in the automotive interior and exterior sector.

The present invention relates to a process for producing colored foamed particles consisting of an elastomer (E), at least comprising the providing of foamed particles made of at least one elastomer (E), and the contacting of the particles with a mixture (M) comprising a dye (F) and a carrier fluid (TF) to obtain colored foamed particles, wherein the carrier fluid (TF) has a polarity suitable for sorption of the carrier fluid into the elastomer. The present invention further relates to colored foamed particles obtained or obtainable by such a process, and to the use of the colored foamed particles of the invention for production of shaped bodies, especially of footwear soles, parts of a footwear sole, bicycle saddles, cushions, mattresses, underlays, handles, protective films, floor coverings, and components in the automotive interior and exterior sector.

Foams, especially also particle foams, have long been known and have been described many times in the literature, for example in Ullmann's “Encyklopädie der technischen Chemie” [Encyclopedia of Industrial Chemistry], 4th edition, volume 20, p. 416-418.

Highly elastic, closed-cell foams, such as particle foams made of thermoplastic polyurethane, that are produced in an autoclave or by the extruder method show good mechanical properties and in some cases also good resilience. Hybrid foams made of particles of thermoplastic elastomers and system foam or binders are also known. Depending on the foam density, the manner of production and the matrix material, it is possible to produce a relatively wide range of stiffness levels overall. Aftertreatment of the foam, such as heat treatment, can also affect the properties of the foam.

Particle foams and shaped bodies based on thermoplastic polyurethane or other elastomers that are produced therefrom are known (e.g. WO 94/20568, WO 2007/082838 A1, WO2017030835, WO 2013/153190 A1 WO2010010010) and have various uses.

Particle foams or foam particles based on thermoplastic polyurethane, also referred to as TPU in this document, are disclosed in WO 94/20568. A disadvantage of the TPU foams described in WO 94/20568 A1 is the high energy expenditure in production and processing. A water vapor pressure of 4.5 bar to 7 bar is employed at temperatures of 145° C. to 165° C. In addition, WO 94/20568 A1 describes expanded, i.e. foamed, TPU particles that can be processed to give shaped articles. These TPU foam particles are produced at temperatures of 150° C. or higher and, as shown by the examples, have a bulk density between 55 and 180 g/L, which is disadvantageous for transport and storage of these particles owing to the elevated space demands.

WO 2007/082838 A1 discloses an expandable, preferably particulate, blowing agent-containing thermoplastic polyurethane, wherein the thermoplastic polyurethane has a Shore hardness between A 44 and A 84. The Shore hardness of the TPU is measured on the compact, i.e. unexpanded, TPU. Moreover, WO 2007/082838 A1 discloses processes for producing expandable, preferably particulate, blowing agent-containing thermoplastic polyurethane and processes for producing expanded thermoplastic polyurethane and processes for producing foam based on thermoplastic polyurethane and foams or expanded thermoplastic polyurethanes obtainable in this way.

Particle foam in the context of the present invention refers to a foam in the form of particles, wherein the average diameter of the particle foam is between 0.2 and 20, preferably 0.5 and 15 and especially between 1 and 12 mm. In the case of non-spherical, elongated or cylindrical, particle foam, diameter means the longest dimension.

For many applications, it is desirable to use colored foamed particles to obtain colored shaped bodies. The prior art discloses, for example, the bonding or foaming of particle foams by means of (colored) polyurethane binders or polyurethane system foams (WO 2008/087078 A1). However, particles coated with colored, crosslinked binders can no longer be subjected to thermoplastic fusion.

The prior art also discloses the production of foamed particles from bulk-colored TPU. However, the coloring of these usually black particles is inadequate since the color intensity of the color changes with the density of the particles. Particles having high density appear darker; those having lower density appear lighter. Coating of the shaped articles produced from foamed particles with a thermoplastic polyurethane, for example, is likewise possible and long-lasting, but the shaped bodies always receive a homogeneous color thereby (WO 2015/165724 A1). The mixing of different-colored particles is not possible.

In principle, it is also possible to color a pelletized material prior to foaming and hence to produce a particle foam. For this purpose, it is necessary to use dyes having very high thermal stability in order to be usable in the extrusion process. However, one disadvantage of this method is that the color intensity changes with the density of the foam. Since the individual particles of a foam batch typically have certain differences in density, the color is usually not homogeneous. Secondly, contaminations arise in the foaming system, and complex cleaning steps are necessary.

It was therefore an object of the present invention to provide foam particles or shaped bodies produced from foam particles, the particles being easy to color and subsequently processable, for example, in a molding machine to give products. It was a further object of the present invention to provide foam particles, or to develop a process that enables coloring of the foam particles independently of the production process therefor and enables high flexibility in the production units, in that initially colorless, i.e. uncolored, particles are produced, and can then be specifically colored and processed further in a downstream process.

This object is achieved in accordance with the invention by a process for producing colored foamed particles consisting of an elastomer (E), at least comprising the steps of
(i) providing foamed particles made of at least one elastomer (E),
(ii) contacting the particles with a mixture (M) comprising a dye (F) and a carrier fluid (TF) to obtain colored foamed particles,

wherein the carrier fluid (TF) has a polarity suitable for sorption of the carrier fluid into the elastomer.

The process of the invention comprises steps (i) and (ii). In step (i), foamed particles made from at least one elastomer (E) are provided. In step (ii) of the process of the invention, the particles are contacted with a mixture (M) comprising a dye (F) and a carrier fluid (TF) to obtain colored foamed particles. It is important in the context of the present invention that the foamed particles provided in step (i) are contacted with the mixture (M) in step (ii) in such a way that the dye present in the mixture (M) can be absorbed by the particles. For example, the mixture (M) can be used in the form of a solution, an emulsion or a dispersion.

In a further embodiment, the present invention therefore relates to a process as described above, wherein the mixture (M) is a solution, emulsion or dispersion.

It has been found that, surprisingly, foamed particles made of an elastomer, especially foamed particles made of thermoplastic elastomers, can be coated with a mixture of pigments and/or dyes with a compatible carrier fluid which is absorbed by the elastomer within a short time. The coated particles can be used to produce single-color or multicolor components that have a permanent color by means of steam fusion, HF fusion or microwave fusion.

The mixture (M) is produced from the carrier fluid (TF) and the dye (F) by processes known per se.

It has been found that good coloring can be achieved when the carrier fluid (TF) used has a polarity suitable for sorption of the carrier fluid into the elastomer. Suitable carrier fluids are known per se to those skilled in the art. Suitable examples are those fluids that have a boiling point in the range from 80° C. to 300° C. Liquids of this kind are also utilized, for example, as plasticizers in the production of elastomers (E).

In the context of the present invention, the carrier fluid is liquid at room temperature.

In a further embodiment, the present invention therefore relates to a process as described above, wherein the carrier fluid has a boiling point in the range from 80° C. to 300° C.

In the context of the present invention, the carrier fluid is preferably a colorless fluid. Further preferably, the carrier fluid in the context of the present invention is not harmful to health and noncorrosive, further preferably nonoxidizing. Preferably, the carrier fluid in the context of the present invention does not have any free acid groups.

A scale customarily used to determine the polarity of liquids is the E_{T}(30) scale. The E_{T}(30) value is defined as the transition energy of the longest-wave vis/NIR absorption band in a solution with the negatively solvatochromic Reichardt dye (Betaine 30) under standard conditions in kcal·mol⁻¹. The E_{T}^{N} value is the E_{T}(30) value normalized to the polarity extremes of tetramethylsilane (=0) and water (=1).

For example, the carrier fluid (TF) used in accordance with the invention has an E_{T}(30) value of not less than 150 kJ/mol, preferably in the range from 150 to 250 kJ/mol, more preferably in the range from 200 to 250 kJ/mol.

In a further embodiment, the present invention therefore relates to a process as described above, wherein the carrier fluid (TF) has an E_{T}(30) value of not less than 150 kJ/mol.

Suitable carrier fluids are selected, for example, from the group consisting of acetone, 1-butanol, dibutyl ether, diethylene glycol, dimethylacetamide, dimethylformamide, dimethyl sulfoxide, 1,4-dioxane, acetic esters, ethyl acetate, water, ethanol, ethylene glycol, ethylene glycol dimethyl ether, 2-propanol (isopropyl alcohol), 3-methyl-1-butanol (isoamyl alcohol), 2-methyl-2-propanol (tert-butanol), methyl ethyl ketone (butanone, propanol, propylene carbonate (4-methyl-1,3-dioxol-2-one), triethylene glycol, triethylene glycol dimethyl ether (triglyme), glycerol esters, phthalic esters, adipic esters, citric esters, polyethylene glycols, polypropylene glycols.

Especially suitable carrier fluids are glycols and esters. Those based on mono-, di- or trialcohols, such as ethanol, propanol, butanol, ethylene glycol, butanediol, glycerol, and on mono- or dicarboxylic acid having 1 to 8 carbon atoms, such as acetic acid, adipic acid, citric acid, phthalic acid, isophthalic acid, terephthalic acid.

In a further embodiment, the present invention therefore relates to a process as described above, wherein the carrier fluid is selected from the group consisting of glycols and of esters of citric acid and glycerol esters.

An example of a suitable carrier fluid in the context of the present invention is triacetin, a glycerol ester.

In the context of the present invention, it is also possible to use mixtures of different carrier fluids.

In the context of the present invention, the mixture (M) is used in an amount sufficient to wet the foamed particles used to an extent of at least 80%, preferably to an extent of at least 90%, further preferably to an extent of 100%.

In the context of the present invention, the mixture (M) is preferably used in an amount in the range from 0.1% to 10% by weight, more preferably in an amount in the range from 0.2% to 5% by weight, especially preferably in the range from 0.3% to 3% by weight, based in each case on the weight of the foamed particles used.

In the context of the present invention, the shape and size of the foamed particles used may vary within wide ranges. According to the invention, the shape of the particles may, for example, be a tetrahedron, cylinder, sphere, lens or polygon, such as a cuboid or octahedron.

The foamed particles are preferably at least approximately spherical and typically have an average diameter at the narrowest point of 1 mm to 20 mm, preferably 2 mm to 12 mm and especially 3 mm to 10 mm.

The contacting in step (ii) is effected for a time sufficient to enable sorption of the mixture (M) on the particle or into the elastomer. The mixture (M) is applied to the particles, for example, by mixing, spray application, drum application or other customary methods.

Typically, the impregnation time in the context of the present invention is not more than 1 hour, for example not more than 30 min, more preferably not more than 10 min.

Preferably, the process in the context of the present invention is conducted such that the dye used penetrates into the foamed particles and remains close to the surface in the particles. For example, the dyes can have a penetration depth of greater than 10 μm, particularly greater than 100 μm, very particularly greater than 500 μm.

In the context of the present invention, it is also possible to achieve a homogeneous distribution of the dye in the particle through suitable choice of the reaction conditions, for example type of dye used or duration of contacting. The distribution of the dye or the penetration depth can be determined, for example, by measurement under a microscope, preferably an electron microscope, on a section of the particle.

According to the invention, the particles are contacted with the mixture (M) and stirred, for example. By virtue of the choice of carrier fluid (TF), the mixture (M) is finely distributed on the surface of the particles and preferably adheres thereon. In the further treatment, for example on heating of the particles, the carrier fluid, for example, also draws into the particles and hence does not disrupt adhesion between the individual particles when they are processed to give shaped bodies.

In the context of the present invention, the carrier fluid can fix the dye on the surface of the foamed particles. However, it is also possible that the carrier fluid entrains the dye into the foam particles and both components remain in the foam particle.

In a further embodiment, the present invention therefore relates to a process as described above, wherein the carrier fluid entrains the dye into the foam particles and both components remain in the foam particle.

In the context of the present invention, the mixture (M) comprises at least one dye. In the context of the present invention, it is possible to use dyes and pigments that are known per se. Suitable dyes or pigments are both liquid and solid dyes or pigments, provided that they are sufficiently miscible with the carrier fluid (TF), such that a mixture (M) is obtained.

In a further embodiment, the present invention therefore relates to a process as described above, wherein the dye is selected from the group consisting of liquid dyes and solid pigments.

The amount of the dye used and the concentration of the dye in the mixture (M) may vary within wide ranges. The amount or concentration of the dye used can be adjusted in order to adjust the color intensity of the colored particles. Preferably, the dye is used in the mixture (M) in an amount in the range from 0.1% to 50% by weight, more preferably in the range from 1% to 30% by weight, especially preferably in the range from 2% to 20% by weight, based in each case on the overall mixture (M).

In the context of the present invention, the dyes used may, for example, be metal complex dyes that have good solubility in polar solvents, for example Neozapon® dyes. It is also possible to use cationic dyes that have good solubility in alcohols and glycol ethers. Suitable dyes are, for example, Basonyl® dyes.

Suitable examples are also commercially available dyes, for example dyes available under the Neozapon® Black X55, Neozapon® Black X51, Neozapon® Red 335, Neozapon® Yellow 141, Neozapon® Red 471, Neozapon® Blue 807, Neozapon® Orange 251, Basonyl® Green 830 liquid, Basonyl® Blue 644 liquid, Basonyl® Red 545 liquid, Basonyl® Red 555 liquid, Basonyl® Green 830 liquid, Basonyl® Blue 636, Basantol® Yellow 099 liquid, Basantol® Black X82 liquid, Neptun Yellow 075, Heliogen® Blue L 6930, Basacid® Orange 282 liquid , Basacid® Yellow 093 liquid, Isopur SU 12021/911 or Reaktint Yellow X15 trade names.

In the context of the present invention, preference is given to using dyes selected from the group consisting of Neozapon® Black X55, Neozapon® Red 335, Neozapon® Orange 251, Basonyl® Green 830 liquid, Basonyl® Blue 644 liquid, Basonyl® Red 545 liquid, Basonyl® Red 555 liquid, Basonyl® Green 830 liquid, Basonyl® Blue 636, and Neptun Yellow 075. More preferably, a dye selected from the group consisting of Basonyl® Blue 644, Basonyl® Red 545, Basonyl® Green 830 and Neozapon® black X55, and Neptun Yellow 075 is used.

According to the invention, foamed particles consisting of at least one elastomer (E) are used. According to the invention, the particles may be open-cell or closed-cell. For example, the closed cell content of the foam is greater than 60%, determined according to DIN ISO 4590:2016. Preferably, the foamed particles, in the context of the present invention, have a closed shell.

The elastomer (E) may vary within wide ranges. Suitable examples include thermoplastic elastomers such as thermoplastic block copolymers. Suitable thermoplastic elastomers are known per se to those skilled in the art. For example, the thermoplastic elastomer may be a thermoplastic polyurethane, a thermoplastic polyetheramide, a polyetherester, a polyesterester or a thermoplastic styrene-butadiene block copolymer. Particularly suitable in the context of the present invention are thermoplastic polyurethanes, polyetheresters, polyesteresters and polyetheramides.

In a further embodiment, the present invention therefore relates to a process as described above, wherein the elastomer is a thermoplastic block copolymer.

In a further embodiment, the present invention therefore relates to a process as described above, wherein the elastomer is selected from the group consisting of thermoplastic polyurethanes, polyetheresters, polyesteresters and polyetheramides.

The thermoplastic elastomers used for production of the foam particles have, for example, a Shore hardness in the range from 30 A to 82 D, preferably in the range from 65 A to 96 A, determined according to DIN 53505. For example, the thermoplastic elastomers used have an elongation at break of greater than 50%, preferably in the range from 200% to 800%, measured according to DIN EN ISO 527-2.

According to the invention, it is also possible to use mixtures of two or more elastomers.

Suitable thermoplastic polyetheresters and polyesteresters can be prepared by all standard methods known from literature by transesterification or esterification of aromatic and aliphatic dicarboxylic acids having 4 to 20 carbon atoms or esters thereof with suitable aliphatic and aromatic di- and polyols (cf. “Polymer Chemistry”, Interscience Publ., New York, 1961, p. 111-127; Kunststoffhandbuch [Polymer Handbook], volume VIII, C. Hanser Verlag, Munich 1973 and Journal of Polymer Science, Part Al, 4, pages 1851-1859 (1966)).

Suitable aromatic dicarboxylic acids include, for example, phthalic acid, iso- and terephthalic acid or esters thereof. Suitable aliphatic dicarboxylic acids include, for example, cyclohexane-1,4-dicarboxylic acid, adipic acid, sebacic acid, azelaic acid and decanedicarboxylic acid as saturated dicarboxylic acids, and maleic acid, fumaric acid, aconitic acid, itaconic acid, tetrahydrophthalic acid and tetrahydroterephthalic acid as unsaturated dicarboxylic acids.

Examples of suitable diol components include diols of the general formula HO—(CH2)n-OH with n=2 to 20, such as ethylene glycol, propane-1,3-diol, butane-1,4-diol or hexane-1,6-diol.

Polyetherols of the general formula HO—(CH2)n-O—(CH2)m-OH where n is equal or unequal to m and n and m=2 to 20, unsaturated diols and polyetherols, for example butene-1,4-diol; diols and polyetherols comprising aromatic units; and polyesterols.

As well as the carboxylic acids mentioned or esters thereof and the alcohols mentioned, it is possible to use any other standard representatives from these classes of compound for provision of the polyetheresters and polyesteresters used in accordance with the invention.

The thermoplastic polyetheramides can be obtained by all standard methods known from literature by reaction of amines and carboxylic acids or esters thereof. Amines and/or carboxylic acid here additionally contain ether units of the R—O—R type where R=organic radical (aliphatic and/or aromatic). In general, monomers from the following classes of compound are used: HOOC—R′—NH2 where R′ may be aromatic and aliphatic, preferably containing ether units of the R—O—R type where R=organic radical (aliphatic and/or aromatic); aromatic dicarboxylic acids including, for example, phthalic acid, iso- and terephthalic acid or esters thereof and aromatic dicarboxylic acids containing ether units of the R—O—R type where R=organic radical (aliphatic and/or aromatic); aliphatic dicarboxylic acids including, for example, cyclohexane-1,4-dicarboxylic acid, adipic acid, sebacic acid, azelaic acid and decanedicarboxylic acid as saturated dicarboxylic acids, and maleic acid, fumaric acid, aconitic acid, itaconic acid, tetrahydrophthalic acid and tetrahydroterephthalic acid as unsaturated and aliphatic dicarboxylic acids containing ether units of the R—O—R type where R=organic radical (aliphatic and/or aromatic); diamines of the general formula H2N—R″—NH2 where R″ may be aromatic and aliphatic, preferably containing ether units of the R—O—R type where R=organic radical (aliphatic and/or aromatic); lactams, for example ε-caprolactam, pyrrolidone or laurolactam; and amino acids.

As well as the carboxylic acids mentioned or esters thereof and the amines, lactams and amino acids mentioned, it is possible to use any other standard representatives from these classes of compound for provision of the polyetheramine used in accordance with the invention.

The thermoplastic elastomers having block copolymer structure that are used in accordance with the invention preferably comprise vinylaromatic units, butadiene units and isoprene units, and polyolefin units and vinylic units, for example ethylene, propylene and vinyl acetate units. Preference is given to styrene-butadiene copolymers.

The thermoplastic elastomers having block copolymer structure, polyetheramides, polyetheresters and polyesteresters that are used in accordance with the invention are preferably chosen such that the melting points thereof are ≤300° C., preferably ≤250° C., especially ≤220° C.

The thermoplastic elastomers having block copolymer structure, polyetheramides, polyetheresters and polyesteresters that are used in accordance with the invention may be semicrystalline or amorphous.

Thermoplastic polyurethanes are also known from the prior art. They are typically obtained by reaction of a polyisocyanate composition with a polyol composition, where the polyol composition typically comprises a polyol and a chain extender.

In the context of the present invention, thermoplastic polyurethanes obtained or obtainable by reaction of a polyisocyanate composition with a polyol composition are typically used.

The expanded particles of the invention can be produced, for example, by suspension or extrusion methods directly or indirectly via expandable particles and foaming in a pressure prefoamer with water vapor or hot air. Suitable methods are known per se to those skilled in the art.

The particle foams of the invention generally have a bulk density of 50 g/l to 200 g/l, preferably 60 g/l to 180 g/l, more preferably 80 g/l to 150 g/l. Bulk density is measured analogously to DIN ISO 697, except that the above values are determined, by contrast with the standard, using a vessel of volume 10 l rather than a vessel of volume 0.5 l, since a measurement with a volume of only 0.5 l is too inaccurate specifically in the case of the foam particles having low density and high mass.

As set out above, the diameter of the particle foams is between 0.5 and 30, preferably 1 and 15 and especially between 3 and 12 mm. In the case of non-spherical, e.g. elongated or cylindrical, particle foam, diameter means the longest dimension.

According to the invention, the process may comprise further steps, for example thermal treatments. It is also possible in the context of the present invention that further coatings or additives are applied to the foamed particles. Suitable methods are known per se to those skilled in the art.

In a further aspect, the present invention also relates to colored foamed particles obtained or obtainable by a process as described above. The present invention thus relates to colored foamed particles obtained or obtainable by a process at least comprising the steps of
(i) providing foamed particles made of at least one elastomer (E),
(ii) contacting the particles with a mixture (MF) comprising a dye (F) and a carrier fluid (TF) to obtain colored foamed particles,

wherein the carrier fluid (TF) has a polarity suitable for sorption of the carrier fluid into the elastomer.

With regard to the preferred embodiments, reference is made to the details above. More particularly, the present invention relates to colored particles as described above, wherein the elastomer is selected from the group consisting of thermoplastic polyurethanes, polyetheresters, polyesteresters and polyetheramides.

The particle foams can be produced by the standard processes known in the prior art by

a. providing the elastomer;

b. impregnating the elastomer with a blowing agent under pressure;

c. expanding the elastomer by means of a pressure drop.

The amount of blowing agent is preferably 0.1 to 40, especially 0.5 to 35 and more preferably 1 to 30 parts by weight, based on 100 parts by weight of the amount of the elastomer used.

One embodiment of the abovementioned process comprises

a. providing the elastomer in the form of a pelletized material;

b. impregnating the pelletized material with a blowing agent under pressure;

c. expanding the pelletized material by means of a pressure drop.

A further embodiment of the abovementioned process comprises a further step:

a. providing the elastomer in the form of a pelletized material;

b. impregnating the pelletized material with a blowing agent under pressure;

c. reducing the pressure to standard pressure without foaming the pelletized material, optionally by prior reduction of the temperature;

d. foaming the pelletized material by an increase in temperature.

The pelletized material here preferably has an average minimum diameter of 0.2-10 mm (determined via 3D evaluation of the pelletized material, for example via dynamic image analysis using an optical measurement apparatus named PartAn 3D from Microtrac).

The individual pellets generally have an average mass in the range from 0.1 to 50 mg, preferably in the range from 4 to 40 mg and more preferably in the range from 7 to 32 mg. This average mass of the pellets (particle weight) is determined as the arithmetic average from the weights of 3 batches of 10 pellet particles each time.

One embodiment of the abovementioned process comprises the impregnating of the pelletized material with a blowing agent under pressure and subsequent expansion of the pelletized material in steps (b) and (c):

b. impregnating the pelletized material in the presence of a blowing agent under pressure at elevated temperatures in a suitable closed reaction vessel (e.g. autoclave);

c. abruptly expanding without cooling.

The impregnation here, in step (b), can be effected in the presence of water and optionally suspension auxiliaries, or solely in the presence of the blowing agent and in the absence of water.

Suitable suspension auxiliaries are, for example, water-insoluble inorganic stabilizers, such as tricalcium phosphate, magnesium pyrophosphate, metal carbonates; and also polyvinyl alcohol and surfactants, such as sodium dodecylarylsulfonate. They are typically used in amounts of 0.05% to 10% by weight, based on the elastomer.

The impregnation temperature, depending on the pressure chosen, is in the range of 100-200° C., where the pressure in the reaction vessel is between 2-150 bar, preferably between 5 and 100 bar, more preferably between 20 and 60 bar; the impregnation time is generally 0.5 to 10 hours.

The performance of the process in suspension is known to the person skilled in the art and is described in detail, for example, in WO 2007/082838.

In the case of performance of the process in the absence of the blowing agent, it should be ensured that aggregation of the polymer pellets is avoided.

Suitable blowing agents for the performance of the process in a suitable closed reaction vessel are, for example, organic liquids and gases that are in a gaseous state under the processing conditions, such as hydrocarbons or inorganic gases or mixtures of organic liquids or gases and inorganic gases, where these may likewise be combined. Suitable hydrocarbons are, for example, halogenated or nonhalogenated, saturated or unsaturated aliphatic hydrocarbons, preferably nonhalogenated saturated or unsaturated aliphatic hydrocarbons. Preferred organic blowing agents are saturated aliphatic hydrocarbons, especially those having 3 to 8 carbon atoms, for example butane or pentane.

Suitable inorganic gases are nitrogen, air, ammonia or carbon dioxide, preferably nitrogen or carbon dioxide or mixtures of the aforementioned gases.

In a further embodiment, the impregnation of the pelletized material with a blowing agent under pressure comprises process and subsequent expansion of the pelletized material in steps (b) and (c):

b. impregnating the pelletized material in the presence of a blowing agent under pressure at elevated temperature in an extruder;

c. pelletizing the mass emerging from the extruder under conditions that prevent uncontrolled foaming.

Suitable blowing agents in this process variant are volatile organic compounds having a boiling point at standard pressure 1013 mbar of −25 to 150, especially −10 to 125° C. Those of good suitability include hydrocarbons (preferably halogen-free), especially C4-10-alkanes, for example the isomers of butane, pentane, hexane, heptane and octane, more preferably isopentane. Further possible blowing agents are also more sterically demanding compounds or functionalized hydrocarbons such as alcohols, ketones, esters, ethers and organic carbonates.

The elastomer here, in step (b), in a melting operation in an extruder, is mixed under pressure with the blowing agent which is supplied to the extruder. The blowing agent-containing mixture is expressed under pressure, preferably with a moderately controlled opposing pressure (e.g.

underwater pelletization), and pelletized. The melt strand foams up here, and the particle foams are obtained by pelletization.

The performance of the process via extrusion is known to the person skilled in the art and described in detail, for example, in WO 2007/082838 and WO 2013/153190 A1.

Useful extruders include all customary screw extruders, especially single-screw and twin-screw extruders (e.g. ZSK type from Werner & Pfleiderer), co-kneaders, Kombiplast machines, MPC kneader/mixers, FCM mixers, KEX kneading screw extruders and shear roll extruders, as described, for example, in Saechtling (ed.), Kunststoff-Taschenbuch [Plastics Handbook], 27th edition, Hanser-Verlag Munich 1998, ch. 3.2.1 and 3.2.4. The extruder is typically operated at a temperature at which the material is in the form of a melt, for example 120° C. to 250° C., especially 150 to 210° C., and a pressure after the addition of the blowing agent of 40 to 200 bar, preferably 60 to 150 bar, more preferably 80 to 120 bar, in order to assure homogenization of the blowing agent with the melt.

The procedure can be effected here in an extruder or an arrangement composed of one or more extruders. For example, in a first extruder, the components can be melted and blended and a blowing agent can be injected. In the second extruder, the impregnated melt is homogenized and the temperature and/or pressure is established. If, for example, three extruders are combined with one another, the mixing of the components and the injecting of the blowing agent can likewise be divided into two different process parts. If, as is preferred, just one extruder is used, all process steps of melting, mixing, injecting the blowing agent, homogenizing and adjusting the temperature and/or pressure are performed in one extruder.

Alternatively, by the methods described in WO 2014150122 or WO 2014150124 A1, the pelletized material can be used to directly produce the corresponding, possibly even already colored, particle foam by impregnating the corresponding pelletized material with a supercritical liquid, from which supercritical liquid is removed, followed by

(α) dipping the article in a heated fluid or

(β) irradiating the article with radiative energy (e.g. infrared or microwave radiation).

Suitable supercritical liquids are, for example, those described in WO 2014/150122 or, for example, carbon dioxide, nitrogen dioxide, ethane, ethylene, oxygen or nitrogen, preferably carbon dioxide or nitrogen.

The supercritical liquid here may also comprise a polar liquid having a Hildebrand solubility parameter of not less than 9 MPa^{1/2}.

The supercritical fluid or heated fluid here may also comprise a dye, which affords a colored foamed article.

The present invention further provides a shaped body produced from the particle foams of the invention.

The foamed particles colored in accordance with the invention can be used to produce shaped bodies, for example by fusing them to one another in a closed mold while heating. For this purpose, for example, the particles are introduced into the mold and, after the mold has been closed, water vapor or hot air is introduced, which results in further expansion of the particles and fusion thereof to one another to give the foam, preferably having a density in the range from 8 to 600 g/L. The foams may be semifinished products, for example slabs, profiles or sheets, or finished shaped articles having simple or complicated geometry. Accordingly, the term “foam” also includes semifinished foam products and shaped foam articles.

In a further aspect, the present invention also relates to a process for producing a shaped body from the colored foamed particles of the invention, or to the use of the colored foamed particles for production of a shaped body. The shaped body may be produced from the foam particles of the invention in a manner known per se. A suitable process is, for example, fusion by means of water vapor, hot air or high-energy radiation.

The corresponding shaped bodies can be produced by methods known to the person skilled in the art. A process preferred here for production of a foam molding comprises the following steps:

(a) introducing the particle foams of the invention into a corresponding mold,

(b) fusing the particle foams of the invention from step (a).

The fusing in step (b) is preferably effected in a closed mold, where the fusing can be effected by means of gases such as steam, hot air (as described, for example, in EP1979401B1) or radiative energy (microwaves or radio waves).

The temperature in the fusing of the particle foam is preferably below or close to the melting temperature of the polymer from which the particle foam has been produced. For the standard polymers, accordingly, the temperature for fusion of the particle foam is between 100° C. and 180° C., preferably between 120 and 150° C.

It is possible here to ascertain temperature profiles/residence times individually, for example in analogy to the processes described in US20150337102 or EP2872309B1.

Welding by means of radiative energy is generally effected within the frequency range of microwaves or radio waves, optionally in the presence of water or other polar liquids, for example microwave-absorbing hydrocarbons that have polar groups (for example esters of carboxylic acids and diols or triols or glycols and liquid polyethylene glycols) and can be effected in analogy to the processes described in EP3053732A or WO2016/146537.

Accordingly, the present invention, in a further embodiment, also relates to the use of the foamed particles as described above, wherein the shaped body is produced by means of fusion or bonding of the particles to one another. In a further embodiment, the present invention also relates to the use of foamed particles as described above for production of a shaped body by fusion of the particles by means of hot steam, hot air, thermal radiation, electromagnetic radiation, such as high-frequency radiation, microwave radiation, NIR radiation, infrared radiation.

The temperature in the fusion of the expanded particles is preferably between 100° C. and 140° C. The present invention thus also provides processes for producing foam based on thermoplastic polyurethane, wherein the expanded thermoplastic polyurethane of the invention is fused by means of water vapor at a temperature between 100° C. and 140° C. to give a shaped body.

The invention also further provides for the use of the expanded particles for production of foams, and foams obtainable from the expanded particles.

In a further aspect, the present invention also relates to shaped bodies obtainable or obtained by the process of the invention for producing a shaped body as described above. Shaped bodies of this kind have not only good mechanical properties but also high elongation at break. Accordingly, the present invention, in a further embodiment, also relates to a shaped body as described above, wherein the shaped body has an elongation at break of greater than 100%, determined according to DIN 53504.

In a further aspect, the present invention also relates to the use of the foam particles or particle foam of the invention or of foam particles obtainable or obtained by a process of the invention for production of footwear soles, bicycle saddles, bicycle tires, damping elements, cushions, mattresses, underlays, handles, protective films, in components in the automotive interior and exterior sector, in balls and sports equipment or as floor covering, especially for sports surfaces, track and field surfaces, sports halls, children's playgrounds and pathways. The present invention further relates to the use of the colored foamed particles of the invention or of foamed particles obtainable by a process of the invention for the in balls and sports equipment or as floor covering and wall paneling, especially for sports surfaces, track and field surfaces, sports halls, children's playgrounds and pathways.

The invention further provides for use of a particle foam of the invention for the production of a shaped body for footwear intersoles, footwear insoles, combination footwear soles, bicycle saddles, bicycle tires, damping elements, cushions, mattresses, underlays, handles, protective films, in components in the automotive interior and exterior sector, in balls and sports equipment or as floorcovering, especially for sports surfaces, track and field surfaces, sports halls, children's playgrounds and pathways.

It is also advantageous that the foams of the invention can be recycled as thermoplastics without difficulty. For this purpose, for example, the foamed materials are extruded using an extruder having a venting device, where the extrusion may optionally be preceded by a mechanical comminution. Thereafter, they can be processed again to give foams in the manner described above.

Further embodiments of the present invention are apparent from the claims and the examples. It will be appreciated that the features of the subject matter/processes/uses of the invention that are mentioned above and elucidated hereinafter can be used not only in the combination specified in each case but also in other combinations without departing from the scope of the invention. For example, the combination of a preferred feature with a particularly preferred feature or of a feature not characterized further with a particularly preferred feature etc. is thus also encompassed implicitly even if this combination is not mentioned explicitly.

Illustrative embodiments of the present invention are detailed hereinafter, but these do not restrict the present invention. More particularly, the present invention also encompasses those embodiments that result from the dependency references and hence combinations that are specified hereinafter.
1. A process for producing colored foamed particles consisting of an elastomer (E), at least comprising the steps of
   (i) providing foamed particles made of at least one elastomer (E),
   (ii) contacting the particles with a mixture (M) comprising a dye (F) and a carrier fluid (TF) to obtain colored foamed particles,
   wherein the carrier fluid (TF) has a polarity suitable for sorption of the carrier fluid into the elastomer.
2. The process according to embodiment 1, wherein the mixture (M) is a solution, emulsion or dispersion.
3. The process according to either of embodiments 1 and 2, wherein the carrier fluid has a boiling point in the range from 80° C. to 300° C.
4. The process according to any of embodiments 1 to 3, wherein the carrier fluid has an E_{T}(30) value of not less than 150 kJ/mol.
5. The process according to any of embodiments 1 to 4, wherein the carrier fluid is selected from the group consisting of glycols and of esters of citric acid and glycerol esters.
6. The process according to any of embodiments 1 to 5, wherein the carrier fluid is triacetin.
7. The process according to any of embodiments 1 to 6, wherein the dye is selected from the group consisting of liquid dyes and solid pigments.
8. The process according to any of embodiments 1 to 7, wherein the dye is selected from the group consisting of metal complex dyes and cationic dyes.
9. The process according to any of embodiments 1 to 7, wherein the dye is selected from the group consisting of Neozapon® Black X55, Neozapon® Black X51, Neozapon® Red 335, Neozapon® Yellow 141, Neozapon® Red 471, Neozapon® Blue 807, Neozapon® Orange 251, Basonyl® Green 830 liquid, Basonyl® Blue 644 liquid, Basonyl® Red 545 liquid, Basonyl® Red 555 liquid, Basonyl® Green 830 liquid, Basonyl® Blue 636, Basantol® Yellow 099 liquid, Basantol® Black X82 liquid, Neptun Yellow 075, Heliogen® Blue L 6930, Basacid® Orange 282 liquid , Basacid® Yellow 093 liquid, Isopur SU 12021/911 or Reaktint Yellow X15.
10. The process according to any of embodiments 1 to 7, wherein the dye is selected from the group consisting of Neozapon® Black X55, Neozapon® Red 335, Neozapon® Orange 251, Basonyl® Green 830 liquid, Basonyl® Blue 644 liquid, Basonyl® Red 545 liquid, Basonyl® Red 555 liquid, Basonyl® Green 830 liquid, Basonyl® Blue 636, and Neptun Yellow 075.
11. The process according to any of embodiments 1 to 7, wherein the dye is selected from the group consisting of Basonyl® Blue 644, Basonyl® Red 545, Basonyl® Green 830, Neozapon® black X55, and Neptun Yellow 075.
12. The process according to any of embodiments 1 to 11, wherein the elastomer is a thermoplastic block copolymer.
13. The process according to any of embodiments 1 to 12, wherein the elastomer is selected from the group consisting of thermoplastic polyurethanes, polyetheresters, polyesteresters and polyetheramides.
14. The process according to any of embodiments 1 to 13, wherein the elastomer is selected from the group consisting of thermoplastic polyurethanes.
15. Colored foamed particles obtained or obtainable by a process at least comprising the steps of
   (i) providing foamed particles made of at least one elastomer (E),
   (ii) contacting the particles with a mixture (M) comprising a dye (F) and a carrier fluid (TF) to obtain colored foamed particles,
   wherein the carrier fluid (TF) has a polarity suitable for sorption of the carrier fluid into the elastomer.
16. Particles according to embodiment 15, wherein the elastomer is selected from the group consisting of thermoplastic polyurethanes, polyetheresters, polyesteresters and polyetheramides.
17. Particles according to embodiment 15 or 16, wherein the mixture (M) is a solution, emulsion or dispersion.
18. Particles according to any of embodiments 15 to 17, wherein the carrier fluid has a boiling point in the range from 80° C. to 300° C.
19. Particles according to any of embodiments 15 to 18, wherein the carrier fluid has an E_{T}(30) value of not less than 150 kJ/mol.
20. Particles according to any of embodiments 15 to 19, wherein the carrier fluid is selected from the group consisting of glycols and of esters of citric acid and glycerol esters.
21. Particles according to any of embodiments 15 to 20, wherein the carrier fluid is triacetin.
22. Particles according to any of embodiments 15 to 21, wherein the dye is selected from the group consisting of liquid dyes and solid pigments.
23. Particles according to any of embodiments 15 to 22, wherein the dye is selected from the group consisting of metal complex dyes and cationic dyes.
24. Particles according to any of embodiments 15 to 22, wherein the dye is selected from the group consisting of Neozapon® Black X55, Neozapon® Black X51, Neozapon® Red 335, Neozapon® Yellow 141, Neozapon® Red 471, Neozapon® Blue 807, Neozapon® Orange 251, Basonyl® Green 830 liquid, Basonyl® Blue 644 liquid, Basonyl® Red 545 liquid, Basonyl® Red 555 liquid, Basonyl® Green 830 liquid, Basonyl® Blue 636, Basantol® Yellow 099 liquid, Basantol® Black X82 liquid, Neptun Yellow 075, Heliogen® Blue L 6930, Basacid® Orange 282 liquid , Basacid® Yellow 093 liquid, Isopur SU 12021/911 or Reaktint Yellow X15.
25. Particles according to any of embodiments 15 to 22, wherein the dye is selected from the group consisting of Neozapon® Black X55, Neozapon® Red 335, Neozapon® Orange 251, Basonyl® Green 830 liquid, Basonyl® Blue 644 liquid, Basonyl® Red 545 liquid, Basonyl® Red 555 liquid, Basonyl® Green 830 liquid, Basonyl® Blue 636, and Neptun Yellow 075.
26. Particles according to any of embodiments 15 to 22, wherein the dye is selected from the group consisting of Basonyl® Blue 644, Basonyl® Red 545, Basonyl® Green 830, Neozapon® black X55, and Neptun Yellow 075.
27. Particles according to any of embodiments 1 to 13, wherein the elastomer is selected from the group consisting of thermoplastic polyurethanes.
28. Colored foamed particles obtained or obtainable by a process according to any of embodiments 1 to 14.
29. The use of foamed particles according to any of embodiments 15 to 28 or of foamed particles obtainable by a process according to any of embodiments 1 to 14 for production of a shaped body.
30. The use according to embodiment 29, wherein the shaped body is produced by means of fusion or bonding of the particles to one another.
31. The use according to embodiment 29 or 30, wherein the shaped body is a footwear sole, part of a footwear sole, a bicycle saddle, a cushion, a mattress, underlay, handle, protective film, a component in the automotive interior and exterior sector.
32. The use of foamed particles according to any of embodiments 15 to 28 or of foamed particles obtainable by a process according to any of embodiments 1 to 14 in balls and sports equipment or as floor covering and wall paneling, especially for sports surfaces, track and field surfaces, sports halls, children's playgrounds and pathways.
33. A process for producing colored foamed particles consisting of an elastomer (E), at least comprising the steps of
   (i) providing foamed particles made of at least one elastomer (E),
   (ii) contacting the particles with a mixture (M) comprising a dye (F) and a carrier fluid (TF) to obtain colored foamed particles,
   wherein the carrier fluid (TF) has a polarity suitable for sorption of the carrier fluid into the elastomer,
   wherein the carrier fluid is selected from the group consisting of glycols and of esters of citric acid and glycerol esters,
   wherein the dye is selected from the group consisting of Neozapon® Black X55, Neozapon® Red 335, Neozapon® Orange 251, Basonyl® Green 830 liquid, Basonyl® Blue 644 liquid, Basonyl® Red 545 liquid, Basonyl® Red 555 liquid, Basonyl® Green 830 liquid, Basonyl® Blue 636, and Neptun Yellow 075.
34. A process for producing colored foamed particles consisting of an elastomer (E), at least comprising the steps of
   (i) providing foamed particles made of at least one elastomer (E),
   (ii) contacting the particles with a mixture (M) comprising a dye (F) and a carrier fluid (TF) to obtain colored foamed particles,
   wherein the carrier fluid (TF) has a polarity suitable for sorption of the carrier fluid into the elastomer,
   wherein the carrier fluid is triacetin,
   wherein the dye is selected from the group consisting of Neozapon® Black X55, Neozapon® Red 335, Neozapon® Orange 251, Basonyl® Green 830 liquid, Basonyl® Blue 644 liquid, Basonyl® Red 545 liquid, Basonyl® Red 555 liquid, Basonyl® Green 830 liquid, Basonyl® Blue 636, and Neptun Yellow 075.
35. A process for producing colored foamed particles consisting of an elastomer (E), at least comprising the steps of
   (i) providing foamed particles made of at least one elastomer (E),
   (ii) contacting the particles with a mixture (M) comprising a dye (F) and a carrier fluid (TF) to obtain colored foamed particles,
   wherein the carrier fluid (TF) has a polarity suitable for sorption of the carrier fluid into the elastomer,
   wherein the carrier fluid is selected from the group consisting of glycols and of esters of citric acid and glycerol esters,
   wherein the dye is selected from the group consisting of Basonyl® Blue 644, Basonyl® Red 545, Basonyl® Green 830, Neozapon® black X55, and Neptun Yellow 075.
36. A process for producing colored foamed particles consisting of an elastomer (E), at least comprising the steps of
   (i) providing foamed particles made of at least one elastomer (E),
   (ii) contacting the particles with a mixture (M) comprising a dye (F) and a carrier fluid (TF) to obtain colored foamed particles,
   wherein the carrier fluid (TF) has a polarity suitable for sorption of the carrier fluid into the elastomer,
   wherein the carrier fluid is triacetin, and
   wherein the dye is selected from the group consisting of Basonyl® Blue 644, Basonyl® Red 545, Basonyl® Green 830, Neozapon® black X55, and Neptun Yellow 075.
37. A process for producing colored foamed particles consisting of an elastomer (E), at least comprising the steps of
   (i) providing foamed particles made of at least one elastomer (E),
   (ii) contacting the particles with a mixture (M) comprising a dye (F) and a carrier fluid (TF) to obtain colored foamed particles,
   wherein the carrier fluid (TF) has a polarity suitable for sorption of the carrier fluid into the elastomer,
   wherein the elastomer is selected from the group consisting of thermoplastic polyurethanes,
   wherein the carrier fluid is selected from the group consisting of glycols and of esters of citric acid and glycerol esters,
   wherein the dye is selected from the group consisting of Neozapon® Black X55, Neozapon® Red 335, Neozapon® Orange 251, Basonyl® Green 830 liquid, Basonyl® Blue 644 liquid, Basonyl® Red 545 liquid, Basonyl® Red 555 liquid, Basonyl® Green 830 liquid, Basonyl® Blue 636, and Neptun Yellow 075.
38. A process for producing colored foamed particles consisting of an elastomer (E), at least comprising the steps of
   (i) providing foamed particles made of at least one elastomer (E),
   (ii) contacting the particles with a mixture (M) comprising a dye (F) and a carrier fluid (TF) to obtain colored foamed particles,
   wherein the carrier fluid (TF) has a polarity suitable for sorption of the carrier fluid into the elastomer,
   wherein the elastomer is selected from the group consisting of thermoplastic polyurethanes,
   wherein the carrier fluid is triacetin,
   wherein the dye is selected from the group consisting of Neozapon® Black X55, Neozapon® Red 335, Neozapon® Orange 251, Basonyl® Green 830 liquid, Basonyl® Blue 644 liquid, Basonyl® Red 545 liquid, Basonyl® Red 555 liquid, Basonyl® Green 830 liquid, Basonyl® Blue 636, and Neptun Yellow 075.
39. A process for producing colored foamed particles consisting of an elastomer (E), at least comprising the steps of
   (i) providing foamed particles made of at least one elastomer (E),
   (ii) contacting the particles with a mixture (M) comprising a dye (F) and a carrier fluid (TF) to obtain colored foamed particles,
   wherein the carrier fluid (TF) has a polarity suitable for sorption of the carrier fluid into the elastomer,
   wherein the elastomer is selected from the group consisting of thermoplastic polyurethanes,
   wherein the carrier fluid is selected from the group consisting of glycols and of esters of citric acid and glycerol esters,
   wherein the dye is selected from the group consisting of Basonyl® Blue 644, Basonyl® Red 545, Basonyl® Green 830, Neozapon® black X55, and Neptun Yellow 075.
40. A process for producing colored foamed particles consisting of an elastomer (E), at least comprising the steps of
   (i) providing foamed particles made of at least one elastomer (E),
   (ii) contacting the particles with a mixture (M) comprising a dye (F) and a carrier fluid (TF) to obtain colored foamed particles,
   wherein the carrier fluid (TF) has a polarity suitable for sorption of the carrier fluid into the elastomer,
   wherein the elastomer is selected from the group consisting of thermoplastic polyurethanes,
   wherein the carrier fluid is triacetin, and
   wherein the dye is selected from the group consisting of Basonyl® Blue 644, Basonyl® Red 545, Basonyl® Green 830, Neozapon® black X55, and Neptun Yellow 075.
41. Colored foamed particles obtained or obtainable by a process according to any of embodiments 33 to 40.
42. Foamed particles according to any of embodiments 15 to 28 or 41, wherein the average diameter of the particle foams is in the range from 0.5 to 15 mm.
43. Foamed particles according to any of embodiments 15 to 28 or 41, wherein the average diameter of the particle foams is in the range from 1 to 12 mm.
44. A process for producing a shaped body from particle foams according to any of embodiments 15 to 28 or 41, comprising
(a) providing the foamed particles;
(b) fusing the particles.
45. The process according to embodiment 44, wherein the fusing in step (b) is effected by means of steam, hot air or radiative energy.
46. The process for producing a shaped body according to either of embodiments 44 and 45, comprising
(a) introducing the particle foams into a corresponding mold,
(b) fusing the particle foams from step (a).
47. The process according to embodiment 46, wherein the fusing in step (b) is effected in a closed mold.
48. The process according to either of embodiments 46 and 47, wherein the fusing in step (b) is effected by means of steam, hot air or radiative energy.
49. A shaped body obtainable or obtained by a process according to any of embodiments 44 to 48.
50. The shaped body according to embodiment 49, wherein the shaped body is a footwear intersole, footwear insole, combination footwear sole, bicycle saddle, bicycle tire, damping element, cushion, mattress, underlay, handle, protective film, in the automotive interior and exterior sector, ball, or floorcovering, especially for sports surfaces, track and field surfaces, sports halls, children's playgrounds and pathways.
51. The use of a particle foam according to any of embodiments 41 to 43 for the production of a shaped body according to of embodiments 49 either/and 50.

The examples which follow serve to illustrate the invention, but are in no way restrictive with respect to the subject matter of the present invention.

### EXAMPLES

1. Feedstocks:
1.1 E-TPU1:
   (Infinergy® 32-100 U10) expanded, predominantly closed-cell foam particles based on thermoplastic polyurethane, obtained by foaming pelletized TPU1 under pressure and at high temperature, particle weight 32 mg, bulk densities 110 g/L.
1.2 E-TPU2:
   (Infinergy® X1125-130U000) expanded, predominantly closed-cell foam particles based on thermoplastic polyurethane, obtained by foaming pelletized TPU1 under pressure and at high temperature, particle weight 25 mg, bulk densities 130 g/L.
1.3 E-TPU3:
   expanded, predominantly closed-cell foam particles based on thermoplastic polyurethane, obtained by foaming pelletized TPU2 under pressure and at high temperature, particle weight 32 mg, bulk densities 90 g/L.
1.4 E-TPU4:
   expanded, predominantly closed-cell foam particles based on thermoplastic polyurethane, obtained by foaming pelletized TPU1 under pressure and at high temperature, particle weight 5 mg, bulk densities 110 g/L.
1.5 E-TPU5:
   expanded, partly closed-cell foam particles based on thermoplastic polyurethane, obtained by foaming pelletized TPU3 under pressure and at high temperature, particle weight 32 mg, bulk densities 90 g/L.
1.6 TPU1:
   thermoplastic polyether polyurethane having a Shore hardness of 80 A based on PTHF1000, butane-1,4-diol, 4,4′-MDI
1.7 TPU2:
   thermoplastic polyether polyurethane having a Shore hardness of 70 A based on PTHF1000, butane-1,4-diol, 4,4′-MDI
1.8 TPU3:
   thermoplastic polyether polyurethane having a Shore hardness of 96 A based on PTHF1000, bisphenol A-started polyether polyol, butane-1,4-diol, 4,4′-MDI
1.9 Adhesive 1:
   Elastopave 6550/101 from BASF Polyurethanes GmbH, compact, 2-component polyurethane system.
1.10 Dyes:
   Usable dyes are in principle all available colorants. Soluble or liquid dyes penetrate into the particles and color them throughout; insoluble dyes such as pigments are fixed on the surface.
   For identification, the dyes were first dissolved in a 1% solution in ethanol and the change in pH was determined. The dyes used are summarized in tables 1 and 2.

TABLE 1

| | | | Solubility in 1% |
|---|---|---|---|
| | Color | pH | solution in ethanol |
| 1 | Neozapon ® Black X55 | 5.9 | ++ |
| 2 | Neozapon ® Black X51 | 4.5 | ++ |
| 3 | Neozapon ® Red 335 | 5.9 | ++ |
| 4 | Neozapon ® Yellow 141 | 7.5 | ++ |
| 5 | Neozapon ® Red 471 | 5.4 | ++ |
| 6 | Neozapon ® Blue 807 | 6.7 | ++ |
| 7 | Neozapon ® Orange 251 | 5.8 | ++ |
| 8 | Basonyl ® Green 830 liquid | 4.9 | ++ |
| 9 | Basonyl ® Blue 644 liquid | 5.4 | ++ |
| 10 | Basonyl ® Red 545 liquid | 5.1 | ++ |
| 11 | Basonyl ® Red 555 liquid | 2.6 | ++ |
| 12 | Basonyl ® Green 830 liquid | 4.3 | ++ |
| 13 | Basonyl ® Blue 636 | 4.3 | ++ |
| 14 | Basantol ® Yellow 099 liquid | 6.7 | ++ |
| 15 | Basantol ® Black X82 liquid | 6.2 | ++ |
| 16 | Neptun Yellow 075 | 7.5 | + |
| 17 | Heliogen ® Blue L 6930 | 6.5 | +− sediment |
| 18 | Basacid ® Orange 282 liquid | 3.5 | + |
| 19 | Basacid ® Yellow 093 liquid | 4.5 | +− sediment |
| 20 | Isopur SU 12021/911 | | |
| 21 | Reaktint Yellow X15 | | |
| | Comparative measurement for | 4.5 | |
| | pure ethanol | | |

TABLE 2

| | | Solubility in 5% | | |
|---|---|---|---|---|
| | | solution in | Coloring potential | |
| | | triacetin | of E-TPU particles | |
| | Color | 1 d | 5 min | 30 min |
| 1 | Neozapon ® Black X55 | ++ | ++ | ++ |
| 2 | Neozapon ® Black X51 | − | +− | +− |
| 3 | Neozapon ® Red 335 | +− | + | ++ |
| 4 | Neozapon ® Yellow 141 | − | −− | −− |
| 5 | Neozapon ® Red 471 | + | − | −− |
| 6 | Neozapon ® Blue 807 | − | −−− | −− |
| 7 | Neozapon ® Orange 251 | +− | + | ++ |
| 8 | Basonyl ® Green 830 liquid | ++ | + | ++ |
| 9 | Basonyl ® Blue 644 liquid | ++ | ++ | ++ |
| 10 | Basonyl ® Red 545 liquid | ++ | + | ++ |
| 11 | Basonyl ® Red 555 liquid | +− | + | ++ |
| 12 | Basonyl ® Green 830 liquid | + | + | + |
| 13 | Basonyl ® Blue 636 | +− | + | ++ |
| 14 | Basantol ® Yellow 099 liquid | − | − | − |
| 15 | Basantol ® Black X82 liquid | + | − | − |
| 16 | Neptun Yellow 075 | − | + | + |
| 17 | Heliogen ® Blue L 6930 | − | +− | +− |
| 18 | Basacid ® Orange 282 liquid | −− | + | + |
| 19 | Basacid ® Yellow 093 liquid | − | −− | −− |
| 20 | Isopur SU 12021/911 | +− | −−− | −−− |
| 21 | Reaktint Yellow X15 | ++ | − | − |

Assessment scale:

+++=very good; +−=average; −−−=very poor

2. Experimental Procedure
2.1 Production of the impregnation mixtures
   A roller bottle is initially charged in each case with 60 g of the dyes (1-21), after the addition of 200 g of glycerol triacetate (triacetin). Once the bottles had been sealed tight, they were agitated on a roller belt at room temperature overnight. The 30% solutions or dispersions of the colorants obtained were then diluted with further triacetin according to the desired color intensity.
2.2 Impregnation of the particle foams
(a) Laboratory scale
   10 g of the E-TPU1-5 in each case were weighed into a roller bottle. After addition of 0.1 g of the color solutions 1-21, the roller bottle was firmly closed and agitated on a roller belt for 5 or 30 min in each case.
   Color intensity and colorability were assessed.
(b) Pilot plant scale
   12 kg of the E-TPU in each case were weighed into a 200 L lidded drum. After the color solutions had been added, the lidded drum was firmly closed and secured in a drum-hoop mixer. After agitation for 8 hours, the drum was removed from the mixer and opened. The colored particles were removed from the vessel; the colors were fixed firmly on the surface or had penetrated into the particles.
2.3 Production of particle foam slabs
   The colored foam particles were then fused in a molding machine from Kurtz ersa GmbH (Boost Foamer) to give square slabs having a side length of 200 mm and a thickness of 10 mm thickness by contacting with water vapor. The fusion parameters of the different materials were chosen such that the slab side of the final shaped article that faced the movable side (MII) of the mold had a minimum number of collapsed ETPU particles. Gap steaming was optionally also effected through the moving side of the mold. Regardless of the experiment, a cooling time of 100 s for a slab of thickness 10 mm from the fixed side (MI) and the moving side of the mold was always established at the end. The respective steaming conditions are dependent on the particle foam used; table 3 lists the vapor pressures.

TABLE 3
Gauge vapor pressures and times
for fusion of the materials

| | Gap | Gap | Gap | Gap |
|---|---|---|---|---|
| | steaming | steaming | steaming | steaming |
| | MI | MI | MII | MII |
| | [bar] | [s] | [bar] | [s] |
| E-TPU1 | 1.8 | 10 | 1.8 | 10 |
| E-TPU2 | 1.8 | 18 | 1.8 | 18 |
| E-TPU3 | 1.4 | 10 | 1.5 | 10 |
| E-TPU4 | 1.5 | 10 | 1.5 | 10 |

The quality of fusion of the slabs can be determined with the aid of various test methods. The results are summarized in Table 4.

TABLE 4
Results for various test methods on 10 mm slab

| | | | 10% | 50% | | Elongation | |
|---|---|---|---|---|---|---|---|
| | | Density of | indentation | indentation | Tensile | under | |
| | | the slab | hardness | hardness | strength | tensile | Resilience |
| E-TPU | Color | (g/cm³) | (kPa) | (kPa) | (MPa) | stress (%) | (%) |
| E-TPU1 | 1 | 0.253 | 78 | 365 | 1.17 | 150 | 70 |
| E-TPU2 | 3 | 0.280 | 25 | 250 | 1.97 | 200 | 65 |
| E-TPU3 | 8 | 0.204 | 15 | 195 | 1.11 | 215 | 68 |
| E-TPU4 | 9 | 0.270 | 35 | 280 | 1.65 | 220 | 66 |
| E-TPU1 | 12 | 0.250 | 76 | 360 | 1.20 | 160 | 70 |
| E-TPU2 | 7 | 0.209 | 40 | 290 | 0.80 | 85 | 65 |
| E-TPU2 | 3 | 0.210 | 40 | 295 | 0.80 | 80 | 65 |
| E-TPU2 | none | 0.206 | 39 | 290 | 0.75 | 85 | 65 |
| comparison | | | | | | | |

Particle foam E-TPU5 was processed to give a molded slab by means of microwave radiation.
45 parts by weight of the colored E-TPU5 foam particles were introduced into a vessel together with 2.4 parts by weight of glycerol triacetate. By agitating the vessel, the E-TPU foam particles had been completely wetted with glycerol triacetate within 60 seconds.
47.4 grams of the wetted and still-loose individual particles were introduced into a microwaveable mold of dimensions 200 mm x 200 mm x 10 mm. Gentle pressure was exerted on the particles by means of a height-adjustable lid. This filled mold was positioned at a 30° angle on the outer edge of the laboratory microwave turntable and irradiated with a power of 400 watts for 40 seconds, the mold was rotated by 180° in the vertical axis and irradiated at 400 W for a further 40 seconds, then the mold was rotated by a further 90° in the vertical axis and then irradiated horizontally at 400 W for a further 40 seconds. The mold was removed from the microwave and cooled down to room temperature in a water bath. It was then possible to remove a fused slab of foam.
2.4 Bonding of colored E-TPU particles 60 g of foam particles of E-TPU1 colored with dye 7 and having a density of 110 g/L were mixed vigorously with 9% by weight of adhesive 1 in a plastic cup for 20 s and bonded in a metal mold to give a shaped foam body of thickness 10 mm. The slab obtained was intensely orange in color.

3. Tests
Indentation hardness in accordance with DIN EN ISO 3386
Resilience DIN 53512

### LITERATURE CITED

Ullmanns “Encyklopädie der technischen Chemie”, 4th edition, volume 20, p. 416-418

WO 94/20568 A1

WO 2007/082838 A1

WO 2008/087078 A1

WO 2015/165724 A1

“Polymer Chemistry”, Interscience Publ., New York, 1961, p. 111-127

Journal of Polymer Science, Part Al, 4, pages 1851-1859 (1966)

WO 2017/030835 A1

WO 2013/153190 A1

WO 2010/010010 A1

Saechtling (Ed.), Kunststoff-Taschenbuch, 27th edition, Hanser-Verlag Munich 1998, Chap. 3.2.1 and 3.2.4

WO 2014/150122 A1

WO 2014/150124 A1

EP 1979401 B1

US 2015/0337102

EP 2872309 B1

EP 3053732 A

WO 2016/146537 A1

1-15. (canceled)

16. A process for producing colored foamed particles consisting of an elastomer (E), the process comprising:
(i) providing foamed particles made of at least one elastomer (E),
(ii) contacting the particles with a mixture (M) comprising a dye (F) and a carrier fluid (TF) to obtain colored foamed particles,
wherein the carrier fluid (TF) has a polarity suitable for sorption of the carrier fluid into the elastomer (E), and the carrier fluid (TF) has an E_{T}(30) value of not less than 150 kJ/mol.

17. The process according to claim 16, wherein the mixture (M) is a solution, emulsion or dispersion.

18. The process according to claim 16, wherein the carrier fluid (TF) has a boiling point in the range from 80° C. to 300° C.

19. The process according to claim 16, wherein the carrier fluid (TF) is selected from the group consisting of glycols and of esters of citric acid and glycerol esters.

20. The process according to claim 16, wherein the dye (F) is selected from the group consisting of liquid dyes and solid pigments.

21. The process according to claim 16, wherein the elastomer (E) is a thermoplastic block copolymer.

22. The process according to claim 16, wherein the elastomer (E) is selected from the group consisting of thermoplastic polyurethanes, polyetheresters, polyesteresters and polyetheramides

23. Colored foamed particles obtained by a process comprising:
(i) providing foamed particles made of at least one elastomer (E),
(ii) contacting the particles with a mixture (M) comprising a dye (F) and a carrier fluid (TF) to obtain colored foamed particles,
wherein the carrier fluid (TF) has a polarity suitable for sorption of the carrier fluid into the elastomer (E), and the carrier fluid (TF) has an E_{T}(30) value of not less than 150 kJ/mol.

24. The particles according to claim 23, wherein the elastomer (E) is selected from the group consisting of thermoplastic polyurethanes, polyetheresters, polyesteresters and polyetheramides.

25. Colored foamed particles obtained by the process according to claim 16.

26. A process for producing a shaped body, comprising employing the foamed particles according to claim 23.

27. The process according to claim 26, wherein the shaped body is produced by fusion or bonding of the particles to one another.

28. The process according to claim 26, wherein the shaped body is a footwear sole, part of a footwear sole, a bicycle saddle, a cushion, a mattress, underlay, handle, protective film, or a component in the automotive interior and exterior sector.

29. A process, comprising employing the foamed particles according to claim 23 in balls and sports equipment or as floor covering and wall paneling.
